(19) United States
(12) Patent Application Publication
(10) Pub. No.: US 2015/0039249 A1
(43) Pub. Date: Feb. 5, 2015

(54) METHOD OF PROVIDING REFERENCE PRESSURES

(71) Applicant: WIKA ALEXANDER WIEGAND SE & CO.KG, Klingenberg/Main (DE)

(72) Inventors: Robert HEINRICH, Moenchberg (DE); Christian ELBERT, Grossostheim (DE); Christian EBERT, Moenchberg (DE)

(21) Appl. No.: 14/452,063

(22) Filed: Aug. 5, 2014

(30) Foreign Application Priority Data
Aug. 5, 2013 (DE) 10 2013 215 351.1

(51) Int. Cl. G01L 19/02; G01L 27/00; G01L 19/12

(52) U.S. Cl. CPC G01L 19/02; G01L 19/12; G01L 27/002
USPC 702/50

(57) ABSTRACT

A method of generating reference pressures by a pressure generator, which generates a reference pressure according to a mass applied to an end face of a piston using a mobile data processor including the steps of: selecting the standard instrument out of a plurality of standard instruments which are measured as regards characteristic properties and the characteristic properties of which are stored in the form of reference data at a central storage location; connecting the mobile data processor to the central storage location and automatically downloading the reference data of the selected standard instrument and storing the same in the mobile data processor; and for processing the reference data, each applied mass and the local environmental data in the measuring environment into the pressure values assigned to the masses applied in each case as the reference pressures of the standard instrument.

This nonprovisional application claims priority under 35 U.S.C. §119(a) to German Patent Application No. DE 10 2013 215 351.1, which was filed in Germany on Aug. 5, 2013, and which is herein incorporated by reference.

### BACKGROUND OF THE INVENTION

1. Field of the Invention

The present invention relates to a method of generating reference pressures. The reference pressures are used to calibrate pressure gauges or pressure sensors.

2. Description of the Background Art

It is a basic requirement for high accuracy of calibration that exact reference pressures are provided, i.e. the reference pressure must be exactly known so as to obtain a reasonable association between the display of the instrument to be calibrated and the pressure actually prevailing at the gauge.

A device for producing reference pressures, also referred to as standard device, is a pressure compensator. As weights and dimensions can be determined very accurately, a pressure compensator makes use of a piston received in a vertical cylinder in a movable and sealing manner the end face of which is loaded with weights and which, corresponding to the applied weights, generates a very exactly determinable pressure in a gas or in a fluid in the cylinder. In order to avoid breakaway forces (stick-slip) and the effects thereof the piston rotates about its longitudinal axis.

The pressure generated by the piston is detected by the gauge or pressure sensor to be calibrated and the display value and, resp., the output signal in response to said pressure is recorded and noted as calibrating log. This operation is carried out for several reference pressures. Preferably for calibration the scale end values or the measuring signal range are divided into plural equal portions, an appropriate reference pressure is adjusted by applying a particular mass (a combination of different weights) in the pressure compensator and the scale value and, resp., the output signal are noted down.

The calibrating log obtained can be delivered with the gauge or pressure sensor, but it can also be used to adapt the scale value and, resp., the output signal on the device side.

In order to satisfy the accuracy of the calibrating operation the pressure compensators are individually calibrated and the individual characteristics thereof (e.g. piston diameter, piston volume, piston speed, surface tension of oil provided around the piston, temperature coefficient of the system etc.) are recorded associated with the respective pressure compensator.

Furthermore, also data from the environment of the pressure compensator have to be considered, e.g. the temperature of the pressure compensator (effects on the piston diameter, capillary forces at the piston etc.) plays an important role. The air pressure, the air temperature and the air humidity are relevant values for computing the force actually exerted on the piston by the weights in that the buoyancy of the weights in the air is appropriately taken into account. Equally, information about the location is important, the geographic height of the location has an influence on the gravitation force to be considered and thus on the force exerted on the piston by the weights applied thereto.

During calibration the entire measuring or detecting range of the instrument to be calibrated should be measured. For this purpose, it is useful to divide the measuring value range into a plurality of equal segments. This is not possible at will, however, due to the bond to a subdivision of the weights, but a combination of the weights that is as close as possible to the theoretical mass value of the respective segment has to be found.

The calibrating operation requires great care in repeating routine steps regarding both the respective performance of computing steps and the reliable and correct logging of the results. The calibrating operation is also time-consuming, as e.g. the division of the measuring range as well as the computing of the subdivision of the weights includes an iterative process.

As a manual process the correct provision of reference pressures and reference pressure values includes a plurality of possible sources of error including reading errors, assigning errors, transmitting errors and logging errors.

### SUMMARY OF THE INVENTION

It is therefore an object of the present invention to provide an improved method of generating reference values by which these errors can be reduced and/or excluded.

The method according to an embodiment of the invention for generating reference pressures makes use of a pressure generator as standard instrument. The pressure generator can be a pressure compensator. In the pressure generator the reference pressure is generated in accordance with a respective mass applied to an end face of a piston. The method is suited for use of a mobile data processor adapted to exchange data for example with the Internet as a central storage location.

The method according to an embodiment of the invention comprises the selection of the standard instrument out of a plurality of standard instruments which are measured as regards characteristic properties and whose characteristic properties are stored at a central storage location in the form of reference data. When the data processor can automatically detect the standard instrument, the standard instrument can be automatically selected.

In the step of connecting the mobile data processor to the central storage location automatic download of the reference data of the selected standard instrument and storage in the mobile data processor are carried out. With the information about the selection of the individual standard instrument the reference data set matching the standard instrument is now downloaded from the central storage location and is stored in the mobile data processor for further use. In this way individual reference data are prevented from having to be entered into the mobile data processor. This is not only time-saving, but it is guaranteed that input data errors or transmission mistakes are avoided. Thus the indication of the reference pressure value becomes more reliable.

In the step of processing the reference data, each applied mass and local environmental data in the measuring environment pressure values assigned to the masses applied in each case are determined and output as the reference pressures of the standard instrument. The respective basis of computation for the reference pressure is the mass applied to the piston in each case, while the reference data and the local environmental data in the measuring environment are used to correct the environmental influences and the properties of the respective standard instrument.

In an advantageous configuration of the invention, the mobile data processor automatically identifies the standard instrument, especially by optical detection, and requests the matching reference data set from the central storage location.

For automatic identification of the standard instrument e.g. a barcode or a so called QR code (registered trademark of Denso Wave Incorporated) can be employed which is arranged on the standard instrument and is read in and evaluated by the camera usually mounted in the mobile data processor (e.g. a tablet PC). With the information from the read and evaluated code the reference data set matching the standard instrument is now downloaded from the central storage location and is stored in the mobile data processor for further use.

In this way it is ensured that the reference data set actually matching the respective standard instrument is downloaded; errors or transmission mistakes in selecting both the standard instrument and the matching reference data set are avoided.

The automatic identification of the standard instrument can also be carried out by other means; these may be radio signals (e.g. Bluetooth), infrared signals output by the standard instrument; there can be used magnetic tapes, RFID labels, scanning chips or similar devices which are suited for transmitting an instrument-specific identifier to the data processor.

Preferably the local environmental data comprise at least one of ambient air pressure, ambient temperature, air humidity, and/or geographic height. These parameters describe, as explained already in the beginning, the measuring environment so as to compensate the influence thereof on the reference pressure. The local environmental data are preferably updated by a measuring station and are transmitted, especially wirelessly, to the mobile data processor. Although it is basically possible to read the values for the local environmental data and input them into the data processor, transmission errors, outdated values can be avoided and the reliability of the reference pressure indication is improved, however, when a data communication is established between a measuring station for the ambient values and the mobile data processor and when the current measuring values are transmitted via the same.

The geographic height can be determined by a GPS sensor of the mobile data processor. In this way, a wrong value can be prevented from being inadvertently used for the geographic height. In addition, the geographic height is determined internally in the instrument which is very comfortable.

The reference data can contain data relating to at least one of piston diameter, piston volume, piston speed, surface tension of oil around the piston and/or temperature coefficient of the system. These reference data are usually detected or combined in connection with the fabrication of the standard instrument and are stored at a central storage location (e.g. a server). In this way there is moreover the option to incorporate new findings relating to the reference data (exacter determination of material values etc.) in the reference data so that upon access to the reference data set by another means an updated data set can be provided here. The reference data set can also be linked to a program update for computing the reference pressure values so that also in this manner well-directed updating can be centrally initiated.

There are also standard instruments comprising exchangeable piston/cylinder arrangements. The reference data set may include data for all piston/cylinder arrangements to be used with the respective standard instrument as well as an inquiry by which the user has to select the actually used piston/cylinder arrangement so as to then utilize the correct data set out of the reference data. The selection may precede the download of the appropriate data set so that only the required reference data are downloaded.

The piston speed as a characteristic property of a standard instrument in the form of a pressure compensator is intended for stationary operation. This speed can be assumed to be constant with the given value. It is possible to detect the speed in the pressure itself and to read said speed into the mobile data processor via a data interface (Bluetooth, infrared, radio etc.) and to consider the actually measured speed instead of a fixed reference value during evaluation.

A set of applicable mass bodies can be assigned to the standard instrument. The masses and dimensions of the mass bodies are stored at the central storage location together with the reference data. Upon delivery of a standard instrument it is common to deliver also a set of weights. The latter can be exactly measured and the measuring data are equally stored within the scope of the reference data. As a consequence, these data together with the reference data of the standard instrument can be downloaded from the central storage location into the mobile data processor.

In the method according to an exemplary embodiment, the combination of the mass bodies of each applied mass can be determined and from the reference data about the exact volume and the mass of the respective mass bodies the mass applied in each case is corrected by the buoyancy of the mass bodies in the ambient air.

The standard instrument can be connected to the mobile data processor via an especially wireless data communication and, when the communication is established, the download of the reference data is automatically initiated via itself or directly to the data processor. This could be configured, for example, so that upon switch-on the standard instrument automatically connects to the central storage location (Internet) and downloads its pertinent reference data. When a data communication with a mobile data processor is established, the data are transmitted to the mobile data processor. In this way the devices are always up-to-date.

In an embodiment of the invention the mobile data processor outputs, between end values of the reference pressures to be provided, plural reference pressure values that can be different from each other in equal sub-steps and pertinent applicable masses. Thus the manual determination of the desired pressures can be dispensed with.

In an embodiment according to the invention combinations of mass bodies to be applied can be determined for setting the reference pressures. In this way the measuring operation can be substantially accelerated, for it is an iterative process for determining the mass body combinations by which pressure being as close as possible to the desired reference pressure is generated. As the mobile data processor knows the subdivision of the mass bodies and also the volume thereof is known, the mass bodies to be applied and the pertinent reference pressure can be indicated very quickly and precisely.

The method according to the invention can be designed in an advantageous configuration so that the mobile data processor can enter into data communication with a pressure measuring device to which the reference pressure is applied and stores the signal output in response to the reference pressure in an assigned manner at the central storage location and/or in the mobile data processor. In this way, reading of a measuring value from the pressure measuring device can be dispensed with and involved sources of error (erroneous reading, error, wrong assignment between reference pressure and signal) are avoided.

A log can be automatically generated and stored in a printable fashion, the log reproducing at least the applied masses, the computed reference pressures as well as the considered environmental data. In the afore-mentioned configuration of the invention in which a pressure measuring device communicating with the data processor is used (measured), the log can be prepared individually for each pressure measuring device. The log contains especially the reference pressures and the pertinent signals or measuring values of the pressure measuring device. When said logs are stored, e.g. output by the data processor and stored at the central storage location, said logs can be used for further rating of the pressure measuring device, e.g. long-term behavior.

Furthermore, a portable control terminal for operating a pressure generator for generating reference pressures is provided. The operating device can include a mobile computing unit comprising a screen and an input configured as a layer on the screen, a memory for storing reference data and geometrical data relating to a pressure generator, a communication module for loading the reference and geometrical data from an external storage location and a computing unit for computing reference points of pressure, wherein the computing unit is adapted to compute a pressure value from local environmental data, masses applied to the pressure generator and the reference and geometrical data of the pressure generator, and wherein the portable control terminal is configured to automatically generate a log that reproduces the deviation of the detected values of a unit under test from pressure test values.

During interaction with a particular pressure generator, for instance a pressure compensator as pressure reference generator, a test log for a unit under test can be prepared by said control terminal in a reliable since largely automated manner.

As mentioned hereinabove, the local environmental data considered also by the portable control terminal can include at least one of ambient air pressure, ambient temperature, air humidity and/or geographic height.

Equally of preference, the reference and geometrical data are device-specific data of the pressure generator and especially relate to the piston diameter and/or the piston volume of the pressure generator.

In an embodiment of the invention the portable control terminal is configured for receiving sensor signals for the floating piston height and/or the rotational speed of the pressure generator and can output an optical and/or acoustic warning signal, when an admissible deviation from a desired value and/or minimum value is exceeded. In this way a potential source of errors can be avoided when testing a unit under test.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic configuration for realizing the selection of the standard instrument and for downloading the reference data from the Internet;

FIG. 2 shows a schematic configuration in which reference data are supplemented by measuring data;

FIG. 3 shows a schematic configuration with automatic detection of measuring values of the pressure measuring instrument to be tested;

FIG. 4 is a schematic representation of a pressure compensator as pressure generator; and

FIG. 5 is a schematic representation of a pressure compensator as pressure generator comprising a sensor technology and an interface.

### DETAILED DESCRIPTION

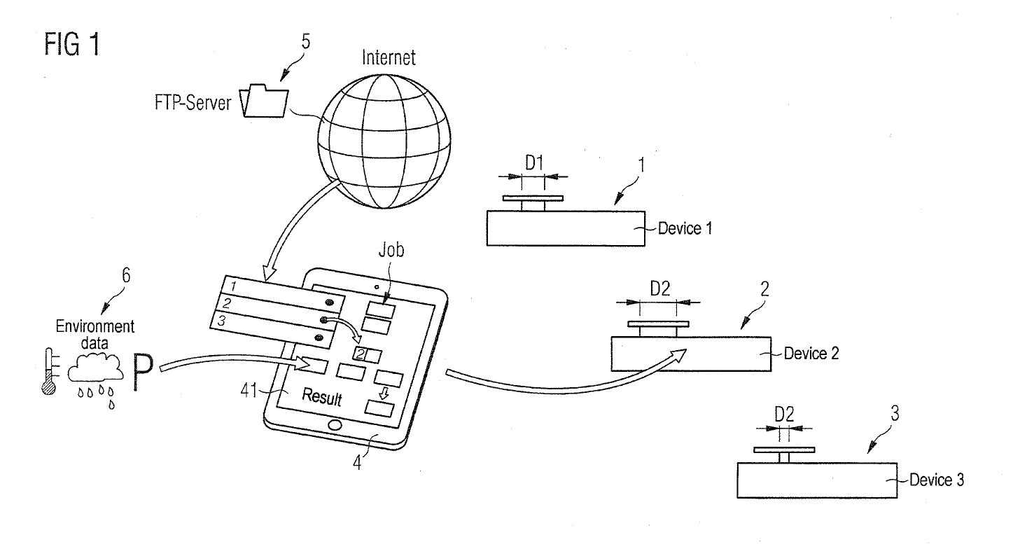

FIG. 1 illustrates an exemplary embodiment of the invention of a configuration comprising three pressure compensators denoted with 1, 2 and 3. Reference numeral 4 designates a mobile data processor which is preferably a so called tablet PC having a touch-sensitive screen. The data processor runs an application, a so called app, which assists the provision of reference pressures according to the claimed method. On the screen 41 a menu is displayed for selecting the number of the pressure compensator to be used. When the user has made his/her choice, the tablet PC connects to the Internet. Usually a WLAN connection to a router (not shown) is established which in turn can connect to a FTP server 5. Via this connection a reference data set assigned to the selected pressure compensator 2 is automatically downloaded and stored in the tablet PC at least for the calibrating function to be executed.

Moreover, reference numeral 6 designates a set of environmental data input in the tablet PC so as to correct the pressure values of the reference pressures generated by applying the mass bodies 21 to the piston of the pressure compensator 2 in accordance with the prevailing ambient conditions.

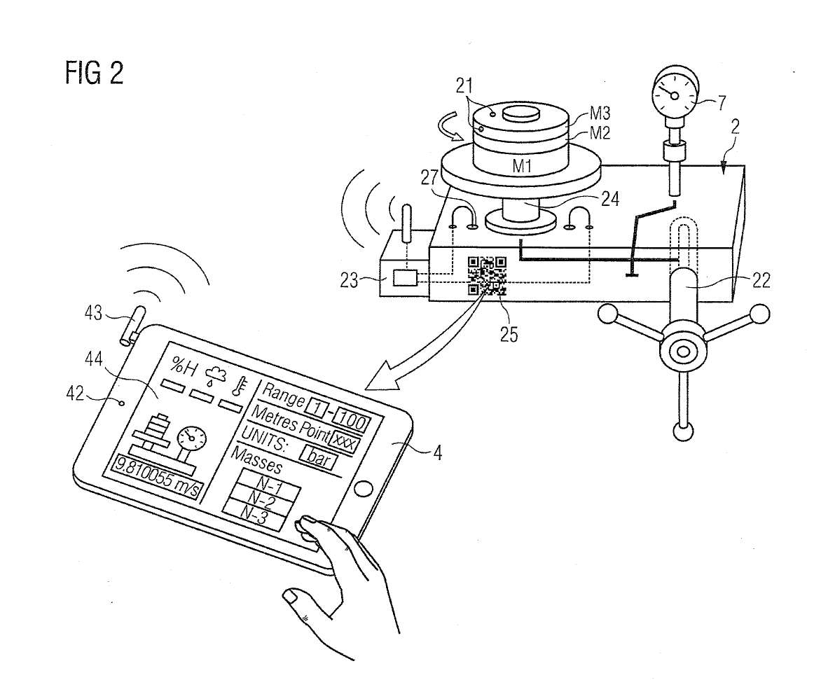

FIG. 2 exemplifies a further automated device constellation by which the method according to the invention can be carried out. A pressure compensator 2 used as standard instrument is shown and explained in detail here. The tablet PC 4 includes a camera 42 and there is provided software by which an image code (here QR code) 25 captured by the camera 42 and visibly arranged on the pressure compensator 2 can be evaluated. Hence the tablet PC 4 as data processor is adapted to automatically identify the number or identifier of the pressure compensator 2 to be used. As illustrated already under FIG. 1, the tablet PC then connects to the Internet and automatically downloads a reference data set pertaining to the pressure compensator 2 from a server as central storage location. These data are stored at least until the calibrating function is fulfilled.

In FIG. 2 a measuring device 7 including pressure gauge is calibrated. The reference pressure generated by the mass bodies 21 applied to the piston is first corrected and the corrected value then is compared and correlated, resp., to the display value of the pressure measuring device 7 entered in the tablet PC.

In the representation of FIG. 2 the pressure compensator 7 and the tablet PC 4 have a radio interface 23 and 43 which may be a Bluetooth interface, for example. Via said interface values for the piston speed can be detected by an assigned sensor system 26 in the vicinity of the piston 24 of the pressure compensator 2 and can be incorporated in the calculations in the tablet PC without the transmission by the user being required. In this case it is not necessary to set a standard piston speed in the centrally stored reference data set.

The piston height detected by another sensor system 27, i.e. the immersion depth of the piston into the cylinder, is equally transmitted to the tablet PC via the interface 23, 43. The piston height is adjustable by means of a hydraulic slider 22 by a handwheel. The signal of the sensor system 27 can be used to display the adjustment of the piston height on the screen of the tablet PC and to request a possibly necessary re-setting by the user. The obtained signal of the sensor system 27 can also be used to correlate the measuring values to the immersion depths and to apply correcting factors or validity criteria to the respective measuring values, where appropriate. In this way, values of inadmissible immersion depth can be dropped or measuring values can be corrected to the effect that capillary forces varied by the immersion depth are taken into account when evaluating the force exerted on the piston and consequently the reference pressure.

The local environmental data are indicated in the left half of the display of the tablet PC. A field 44 is indicative of the gravitational acceleration depending on the geographic height. A GPS (Global Positioning System) receiver for a satellite navigation system mounted in the tablet PC is almost standard in such devices, as said devices are frequently employed as and equipped for navigation systems. From the GPS signal the geographic height can be determined by which then the gravitational acceleration to be entered is automatically determined. It may be required for the purpose of satellite contact to expose the tablet PC to the unhindered view to the sky at the same height as the measuring space.

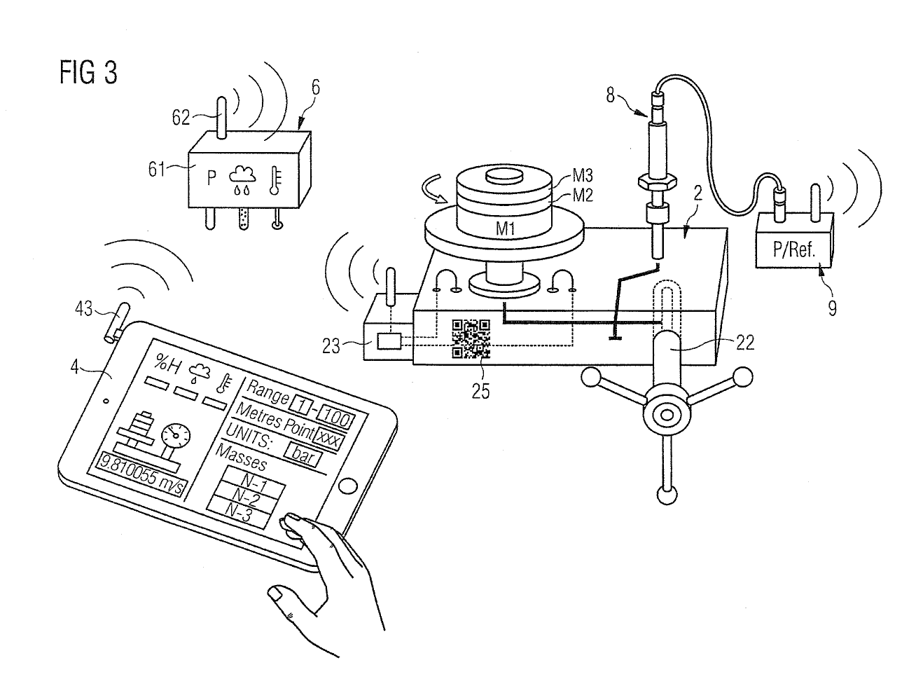

FIG. 3 exemplifies a further automated device constellation by which the method can be implemented largely automatically. In addition to FIG. 2, whose description is expressly intended to be analogously applicable to the present FIG. 3 including the described cycles and the elements designated with the same reference numerals, in the arrangement of FIG. 3 a pressure sensor 8 is connected to the pressure compensator 2 as pressure measuring device to be calibrated.

The pressure sensor 8 is connected to a radio interface 9 for transmitting the pressure values to the interface 43 of the tablet PC 4 in response to applying the reference pressures to the pressure sensor 8. Hence it is not required in this arrangement to read and enter the measured pressure values, but this is performed automatically.

Furthermore, a measuring station 61 is arranged in the measuring environment of the pressure compensator 2 and detects the local environmental data. The measuring station 61 transmits the current measuring values via a radio interface 62 being communicated with the radio interface 43 of the tablet PC 4 and receiving the local environmental data and entering the same into the tablet PC 4. In this case calibration is further facilitated by the automated input of measuring values. The values for each generated reference pressure are thus rendered more accurate and more reliable.

The obtained calibrating data can be stored as a log in the tablet PC and can be optionally printed or stored in the central storage location (server) via Internet.

The examples illustrated here describe the use of a tablet PC which, by way of example, serves as mobile data processor; also a laptop, a smartphone or a similar device can be used.

There exist pressure compensators the operating range of which is variable by exchanging piston/cylinder units. In this case, it can be provided that the selection of the reference data set to be downloaded from a server as central storage location takes the selected piston/cylinder unit into account. This can also be done in the same way as described by the detection and evaluation of the code on the pressure compensator, wherein for this purpose the code is arranged on the piston/cylinder unit.

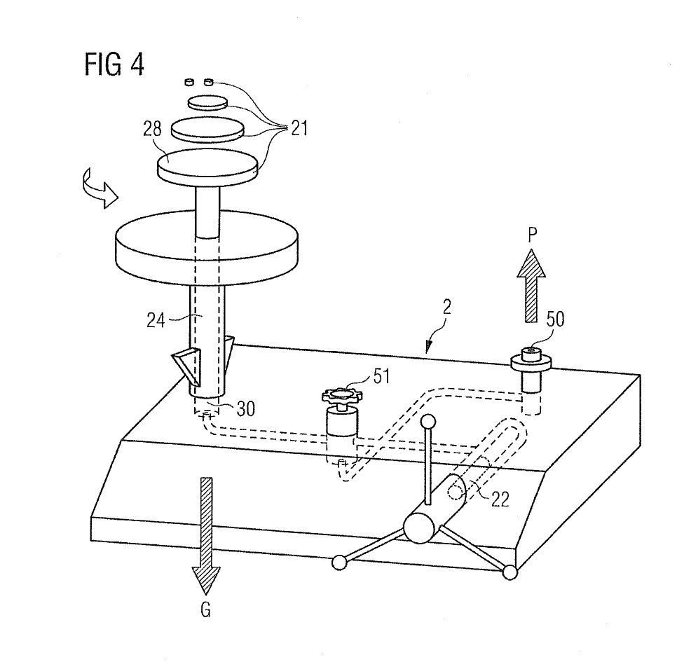

FIG. 4 illustrates a pressure compensator comprising a rotary disk or rotating piston disk 28, a piston 24 of a piston/cylinder system connected to and acting on a hydraulic system 30. The device to be tested (measuring device or pressure converter, not shown) is connected to the test terminal 50. The volume slide 22 acts on the hydraulic system 30 so as to adjust the floating height of the piston 24 (piston height). A fill nozzle 51 permits re-filling hydraulic fluid.

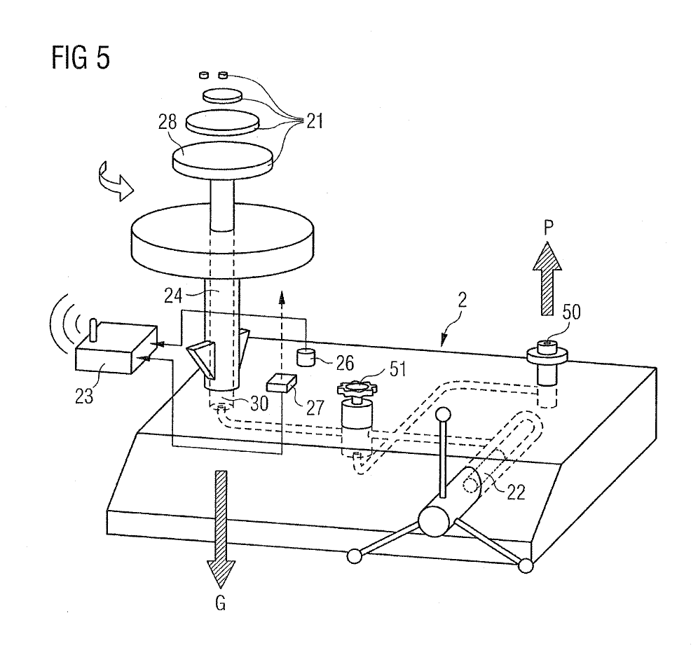

FIG. 5 illustrates a pressure compensator 2 comprising the same elements as described before by way of the preceding figures already, wherein the same reference numerals are used for the same element. Thus the corresponding description is also applicable here. The pressure compensator 2 includes a sensor system 26, 27 by which the floating piston height (sensor 27) and the piston speed or disk speed (sensor 26) are measured. An interface 23 is set as radio interface and is adapted to output the values detected by the sensor system 26, 27 so that said values then can be received and processed by the portable control terminal or the mobile data processor.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method of generating reference pressures via a pressure generator as a standard instrument or a pressure compensator, which generates a reference pressure according to a mass applied in each case to an end face of a piston using a mobile data processor, the method comprising:
selecting the standard instrument from a plurality of standard instruments measured with respect to characteristic properties, the characteristic properties being stored as reference data at a central storage location;
connecting the mobile data processor to the central storage location and automatically downloading the reference data of the selected standard instrument and storing the reference data in the mobile data processor; and
processing the reference data, each applied mass and local environmental data in the measuring environment into pressure values assigned to the masses applied in each case as the reference pressures of the standard instrument.

2. The method according to claim 1, wherein the mobile data processor independently identifies the standard instrument by optical detection, and requests the matching reference data set from the central storage location.

3. The method according to claim 1, wherein the local environmental data includes at least one of ambient air pressure, ambient temperature, air humidity, or geographic height.

4. The method according to claim 3, wherein the local environmental data are updated by a measuring station and are transmitted to the mobile data processor.

5. The method according to claim 3, wherein the geographic height is determined by a GPS sensor of the mobile data processor.

6. The method according to claim 1, wherein the reference data contain data relating to at least one of a piston diameter, a piston volume, a piston speed, a surface tension of oil around the piston, or a temperature coefficient of the system.

7. The method according to claim 1, wherein a set of applicable mass bodies is assigned to the standard instrument and masses and dimensions of the mass bodies are stored together with the reference data at the central storage location and are downloaded from the central storage location together with the reference data of the standard instrument into the mobile data processor.

8. The method according to claim 7, wherein the combination of the mass bodies of the mass applied in each case is determined and the mass applied in each case is corrected by a buoyancy of the mass bodies in ambient air.

9. The method according to claim 1, wherein the standard instrument is connectable to the mobile data processor via wireless data communication, and upon establishing the communication automatically initiates the download of the reference data via itself or directly to the data processor.

10. The method according to claim 1, wherein the mobile data processor outputs, between end values of the reference pressures to be provided, plural reference pressure values that are different from each other in equal sub-steps and pertinent masses to be applied.

11. The method according to claim 10, wherein combinations of mass bodies to be applied are determined by which the reference pressures are adjusted.

12. The method according to claim 1, wherein the mobile data processor is adapted to enter into data communication with a pressure measuring device to which the reference pressure is applicable and stores the signal output in response to the reference pressure in an assigned manner at the central storage location and/or in the mobile data processor.

13. The method according to claim 1, wherein automatically a log reproducing at least the applied masses, the computed reference pressures or the considered environmental data is generated and stored in a printable manner.

14. The method according to claim 12, wherein each log is prepared individually for a pressure measuring device to which the reference pressure is applicable, and wherein the log includes reference pressures and pertinent signals of the pressure measuring device.

15. A portable control terminal for operating a pressure generator for generating reference pressures, the portable control terminal comprising:
a mobile computing unit having a screen and an input as a layer on the screen;
a memory for storing reference data and geometrical data relating to a pressure generator,
a communication module for loading the reference and geometrical data from an external storage location; and
a computing unit for computing reference points of pressure, the computing unit being adapted to compute a pressure value from local environmental data, masses applied to the pressure generator, and the reference and geometrical data of the pressure generator,
wherein the portable control terminal is configured to automatically generate a log reproducing the deviation of the detected values of a unit under test from pressure test values.

16. The portable control terminal according to claim 15, wherein the local environmental data contain at least one of ambient air pressure, ambient temperature, air humidity, or geographic height, and wherein the reference and geometrical data are device-specific data of the pressure generator and relate to a piston diameter and/or a piston volume of the pressure generator.

17. The portable control terminal according to claim 15, wherein the control terminal is configured to receive sensor signals for the floating piston height and/or the rotational speed of the pressure generator and is configured to output an optical and/or acoustic warning signal when an admissible deviation from a desired value and/or minimum value is exceeded.

18. The method according to claim 4, wherein the transmission is performed wirelessly.
